(19) United States
(12) Patent Application Publication
(10) Pub. No.: US 2026/0342096 A1
(43) Pub. Date: Oct. 29, 2026

(54) POWER SUPPLY SYSTEM AND CONTROL METHOD THEREOF

(71) Applicant: Delta Electronics, Inc., Taoyuan City (TW)

(72) Inventors: Wenjie Sun, Shanghai (CN); Lei Jia, Shanghai (CN); Mengyu Liang, Shanghai (CN); Feidong Xu, Shanghai (CN)

(21) Appl. No.: 19/643,547

(22) Filed: Apr. 9, 2026

(30) Foreign Application Priority Data
Apr. 23, 2025 (CN) 202510515763.8

(51) Int. Cl. H02J 3/38; H02J 3/32; H02J 7/82; H02J 7/90; H02J 101/24; H02M 1/00

(52) U.S. Cl. CPC H02J 3/38; H02J 3/32; H02J 7/82; H02J 7/933; H02M 1/0032; H02J 2101/25; H02J 2207/20

(57) ABSTRACT

A power supply system includes an inverter and a plurality of energy conversion devices. Each energy conversion device includes an energy storage battery, a power supply sub-device and a power conversion system. The control method includes the following steps. Firstly, a step (S1) is performed to determine a working mode of a first energy conversion device of the plurality of energy conversion devices, wherein the working mode includes an operating mode and a standby mode. Then, a step (S2) is performed to determine whether the first energy conversion device requires charging or discharging according to a power reference command. Then, a step (S3) is performed to determine whether to switch the working mode of the first energy conversion device based on a state of charge of the energy storage battery in the first energy conversion device.

### CROSS-REFERENCE TO RELATED APPLICATIONS

This application claims priority to China Patent Application No. 202510515763.8 filed on Apr. 23, 2025. The entire contents of the above-mentioned patent application are incorporated herein by reference for all purposes.

### FIELD OF THE INVENTION

The present disclosure relates to a power supply technology, and more particularly to a power supply system and a control method for the power supply system.

### BACKGROUND OF THE INVENTION

A power conversion system (PCS) is a peripheral device that connects the user equipment, the power grid and loads. The power conversion system may be operated in either a grid-connected mode or an off-grid mode. In the off-grid mode, the power conversion system functions as a voltage source to provide voltage support, and the power conversion system forms a local microgrid system with household local loads, photovoltaic (PV) inverters, and other power consumption or generation devices. Furthermore, in the off-grid mode, a plurality of power conversion systems may be connected in parallel to increase system capacity and enhance power supply reliability.

Furthermore, when multiple power conversion systems are used in conjunction with energy storage batteries and photovoltaic inverters, more flexible power management system may be provided. However, in off-grid mode, the basic requirements for parallel operations of the multiple power conversion systems are important, and the coordination of the power conversion systems with the energy storage batteries and PV inverters needs to be taken into consideration.

Generally, the energy storage batteries connected to the power conversion system may only perform charging/discharging operations within a specified range of the state of charge (SOC). In addition, the PV inverters are operated in a maximum power point (MPP) tracking manner and are not equipped with energy storage batteries. In order to ensure overall power balance, the following conditions should be taken into account. For example, the discharging operation of the energy storage battery should be stopped when the SOC is low, and the charging operation of the energy storage battery should be stopped when the SOC is high.

In order to meet these requirements, a conventional approach is to adjust all power conversion systems to maintain their energy storage batteries to be at the similar SOC levels during normal operation. If the SOC of the energy storage battery in any power conversion system is too low, all power conversion systems are shut down. Whereas, if the SOC of the energy storage battery in any power conversion system is too high and the PV inverter continuously generates electric power, all power conversion systems will synchronously adjust their output frequencies to reduce the output power of the PV inverters.

However, the above control strategy is relatively complex. For example, numerous variables need to be monitored and regulated, and the control strategy is correspondingly adjusted according to changes in the number of power conversion systems. Furthermore, this control strategy can only be implemented in either a centralized configuration or a master-slave configuration. In case that the centralized configuration is adopted, additional centralized control units and communication networks are required, which increases system cost. In case that the master-slave configuration is adopted, an additional energy management strategy needs to be executed. The additional energy management strategy places significant computational pressure on the microcontroller unit (MCU) of the master power conversion system and reduces the overall reliability of parallel operation of the power conversion systems.

In order to overcome the drawbacks of the conventional technologies, it is important to provide an improved power supply system and a control method for the power supply system.

### SUMMARY OF THE INVENTION

In accordance with an aspect of the present disclosure, a control method for a power supply system is provided. The power supply system includes an inverter and a plurality of energy conversion devices. The plurality of energy conversion devices are electrically connected to each other. An output terminal of each of the plurality of energy conversion devices is electrically connected to the inverter via a common terminal. Each of the plurality of energy conversion devices includes an energy storage battery, a power supply sub-device and a power conversion system. The control method includes the following steps. Firstly, a step (S1) is performed to determine a working mode of a first energy conversion device of the plurality of energy conversion devices, wherein the working mode includes an operating mode and a standby mode. Then, a step (S2) is performed to determine whether the first energy conversion device requires charging or discharging according to a power reference command. Then, a step (S3) is performed to determine whether to switch the working mode of the first energy conversion device based on a state of charge of the energy storage battery in the first energy conversion device.

In accordance with another aspect of the present disclosure, a power supply system is provided. The power supply system includes an inverter and a plurality of energy conversion devices. The plurality of energy conversion devices are electrically connected to each other. An output terminal of each of the plurality of energy conversion devices is electrically connected to the inverter via a common terminal. Each of the plurality of energy conversion devices includes an energy storage battery, a power supply sub-device and a power conversion system. A first energy conversion device of the plurality of energy conversion devices performs a control method. The control method includes the following steps. Firstly, a step (S1) is performed to determine a working mode of a first energy conversion device of the plurality of energy conversion devices, wherein the working mode includes an operating mode and a standby mode. Then, a step (S2) is performed to determine whether the first energy conversion device requires charging or discharging according to a power reference command. Then, a step (S3) is performed to determine whether to switch the working mode of the first energy conversion device based on a state of charge of the energy storage battery in the first energy conversion device.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a simplified flowchart illustrating a control method for a power supply system according to an embodiment of the present disclosure;

FIG. 2 is a detailed flowchart of the control method of FIG. 1;

FIG. 3 is a schematic circuit diagram illustrating the circuitry topology of the power supply system using the control method of FIG. 1; and

FIG. 4 is a plot illustrating the relationship between the output power and the voltage frequency of the inverter in the power supply system shown in FIG. 3.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

In this context, the terms “first”, “second”, etc. do not specifically refer to order or sequence, nor are they used to limit this application. They are only used to distinguish between elements or operations described by the same technical terms. The terms “including”, “comprising”, “having” and “containing” used in this context are all open terms, which mean including but not limited to. Unless otherwise expressly specified or limited, the term “connected” and the term “coupled” should be understood in a broad sense. For example, two or more elements are in direct physical or electrical contact, or two or more elements are in indirect physical or electrical contact with each other.

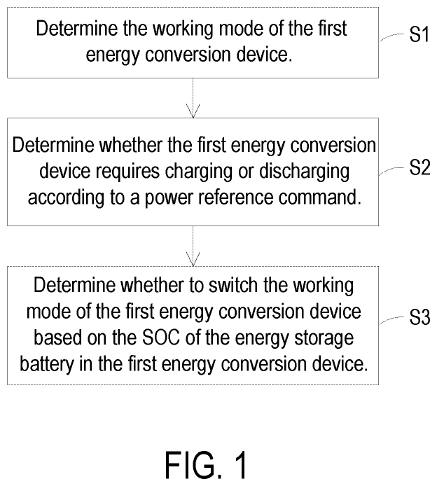

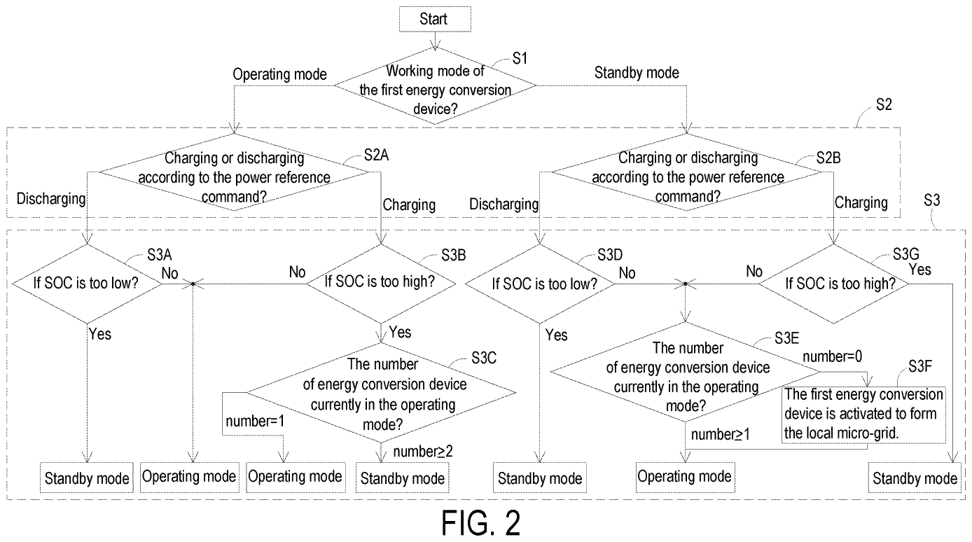

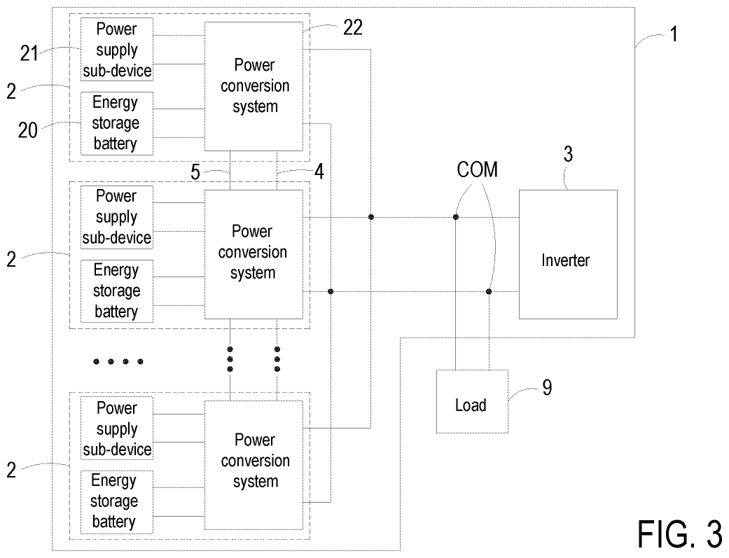

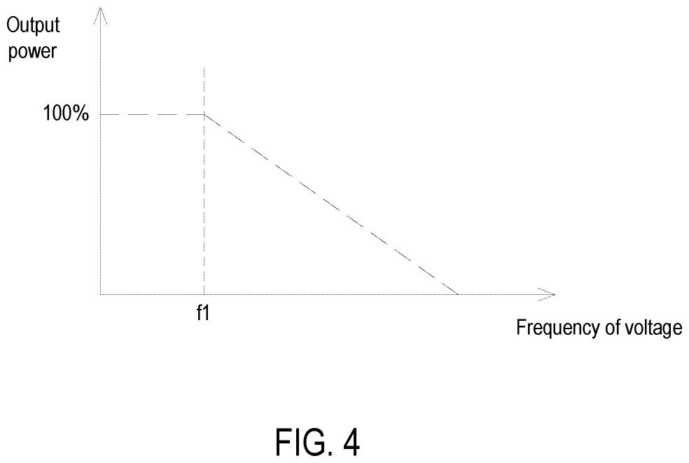

Please refer to FIGS. 1, 2, 3 and 4. FIG. 1 is a simplified flowchart illustrating a control method for a power supply system according to an embodiment of the present disclosure. FIG. 2 is a detailed flowchart of the control method of FIG. 1. FIG. 3 is a schematic circuit diagram illustrating the circuitry topology of the power supply system using the control method of FIG. 1. FIG. 4 is a plot illustrating the relationship between the output power and the voltage frequency of the inverter in the power supply system shown in FIG. 3. The control method of the present disclosure is suitably applied to the power supply system 1 shown in FIG. 3.

Preferably but not exclusively, the power supply system 1 is a photovoltaic power supply system. In an embodiment, the power supply system 1 includes an inverter 3 and a plurality of energy conversion devices 2. Preferably but not exclusively, the inverter 3 is a photovoltaic inverter, and the inverter 3 is electrically connected to a common terminal COM. Furthermore, the inverter 3 is operated in a maximum power tracking (MPP) manner and is not equipped with any energy storage battery. The electric energy received from other energy sources is converted into regulated electric energy by the inverter 3, and the regulated electric energy is outputted to the common terminal COM. In case that the inverter 3 is a photovoltaic inverter, the inverter 3 may convert the received solar energy (not shown) into the regulated electric energy and provide the regulated electric energy to the common terminal COM. In some embodiments, at least one load 9 is electrically connected to the common terminal COM, and the at least one load 9 receives electric power via the common terminal COM.

The output terminals of these energy conversion devices 2 are electrically connected to the common terminal COM, and are electrically connected to the inverter 3 via the common terminal COM.

Furthermore, each energy conversion device 2 may perform bidirectional power conversion. In an embodiment, each energy conversion device 2 includes an energy storage battery 20, a power supply sub-device 21 and a power conversion system 22 (PCS). The energy storage battery 20 may be charged or discharged through the power conversion system 22. For example, the power supply sub-device 21 is a photovoltaic power generation unit, which can supply power to the energy storage battery 20 through the power conversion system 22. The power conversion system 22 is a bidirectional power converter.

In an embodiment, each energy conversion device 2 may be operated in one of two working modes. These two working modes include an operating mode and a standby mode. When the energy conversion device 2 is in the operating mode, the energy conversion device 2 can perform external charging/discharging operations to enable the bidirectional energy flow. During the external charging operation, the energy conversion device 2 receives the input electric energy through the common terminal COM. During the external discharging operation, the energy conversion device 2 outputs electric energy to the common terminal COM. When the energy conversion device 2 is in the standby mode, the energy conversion device 2 stops performing the external charging/discharging operations. Meanwhile, the energy conversion device 2 does not exchange energy with the common terminal COM.

In an embodiment, the power supply system 1 further includes a CAN bus 4. Each energy conversion device 2 is electrically connected to the CAN bus 4. The plurality of energy conversion devices 2 are in communication with each other through the CAN bus 4 in order to exchange the information about the output power, the working mode and other specific commands of individual energy conversion device 2. In an embodiment, the power supply system 1 further includes a phase synchronization signal line 5 (Synchronization, SYNC). Each energy conversion device 2 is electrically connected to the phase synchronization signal line 5. The plurality of energy conversion devices 2 are in communication with each other through the phase synchronization signal line 5. Through the phase synchronization signal line 5, each energy conversion device 2 can adjust the phase of its output voltage to reduce circulating current.

The control method can be applied to any arbitrary energy conversion device 2 of the power supply system 1 shown in FIG. 3. In addition, all energy conversion devices 2 can implement the control method simultaneously. To facilitate understanding the concepts of the present disclosure, one of the energy conversion devices 2 implementing the control method will be referred to as a first energy conversion device 2.

As shown in FIG. 1, the control method of the present disclosure comprises the following steps. Firstly, a step S1 is performed to determine the working mode of the first energy conversion device 2, wherein the working mode includes an operating mode and a standby mode. Then, a step S2 is performed to determine whether the first energy conversion device requires charging or a discharging according to a power reference command. Then, a step S3 is performed to determine whether to switch the working mode of the first energy conversion device 2 based on a state of charge (SOC) of the energy storage battery 20 in the first energy conversion device 2.

In the step S1, each energy conversion device 2 can determine its working mode through a controller (not shown) therein. That is, it is not necessary for an external active control device to provide the information about the working mode of each energy conversion device 2.

In the step S2, each energy conversion device 2 determines whether to perform the external charging operation or the external discharging operation according to its own power reference command P_{ref}. If a decentralized control strategy is adopted, each energy conversion device 2 independently calculates its own power reference command P_{ref}. If a centralized control strategy is adopted, the power supply system 1 is equipped with a dedicated master controller to send the power reference commands P_{ref} to each energy conversion device 2.

Furthermore, if P_{ref}>0, the power reference command instructs the energy conversion device 2 to discharge externally; and if P_{ref}<0, the power reference command instructs the energy conversion device 2 to charge externally.

A procedure for determining the power reference command P_{ref} will be described as follows:

Firstly, the average power P_{avg} of all energy conversion devices 2 currently in the operating mode is calculated. This average power P_{avg} is obtained by summing the output power of each operating energy conversion device 2 and dividing by the total number. The output power of each energy conversion device 2 is transmitted through the CAN bus 4. The formula for calculating the average power may be expressed as:

$${P}_{avg} = \frac{1}{k} {\sum }_{i}^{k} {P}_{i}$$

In the above formula, P_{avg} is the average power, k is the number of energy conversion devices currently in the operating mode, and Pᵢ is output power of the i-th energy conversion device in the operating mode, where i is a positive integer.

For each energy conversion device 2 in the operating mode, the power reference command P_{refi} is calculated using the following formula: P_{refi}=P_{avg}−Pₚᵥᵢ. In this formula, Pₚᵥᵢ is the output power supplied to the internal power supply sub-device 21 of the energy conversion device 2. The power reference command P_{refi} represents the desired power for the energy storage battery 20 in the operating energy conversion device 2.

For the energy conversion devices 2 in standby mode, Pj represents the output power of the j-th energy conversion device 2, where j is a positive integer. Correspondingly, the power reference command P_{refj} is calculated using the following formula: P_{refj}=P_{avg}. This power reference command P_{refj} represents the desired power from the common terminal COM for the energy conversion devices 2 in standby mode.

In the step S3, the SOC of the energy storage battery 20 refers to the state of charge of the energy storage battery 20. When the working mode of the energy conversion device 2 is switched, the power reference command of the energy conversion device 2 and the SOC of its energy storage battery 20 should be taken into consideration.

The operations of the control method for the power supply system will be illustrated in more detail as follows.

Please refer to FIG. 2. If the determination in the step S1 indicates that the working mode of the first energy conversion device 2 is the operating mode, a sub-step S2A of the step S2 is performed to determine whether the first energy conversion device 2 needs to undergo the charging operation or the discharging operation according to the power reference command. That is, the sub-step S2A is performed to determine whether the energy storage battery 20 in the first energy conversion device 2 needs to undergo the charging operation or the discharging operation.

If the determination in the sub-step S2A indicates that the energy storage battery 20 in the first energy conversion device 2 needs to undergo the discharging operation, a sub-step S3A of the step S3 is performed to determine whether the SOC of the energy storage battery 20 in the first energy conversion device 2 is too low. If the SOC of the energy storage battery 20 in the first energy conversion device 2 is less than a first lower threshold, it is determined that the SOC of the energy storage battery 20 in the first energy conversion device 2 is too low. Furthermore, the working mode of the first energy conversion device 2 can be switched according to the comparison result of the sub-step S3A. If the comparison result of the sub-step S3A indicates that the SOC of the energy storage battery 20 in the first energy conversion device 2 is less than the first lower threshold, the working mode of the first energy conversion device 2 is switched to the standby mode. Whereas, if the comparison result of the sub-step S3A indicates that the SOC of the energy storage battery 20 in the first energy conversion device 2 is greater than the first lower threshold, the working mode of the first energy conversion device 2 is maintained in the operating mode.

As mentioned above, if the comparison result of the sub-step S3A indicates that the SOC of the energy storage battery 20 in the first energy conversion device 2 is less than the first lower threshold, the working mode of the first energy conversion device 2 is switched to the standby mode. Although the energy conversion device 2 does not exchange energy with the common terminal COM, the power supply sub-device 21 in the first energy conversion device 2 can charge the energy storage battery 20 through the power conversion system 22. Consequently, the SOC of the energy storage battery 20 in the first energy conversion device 2 will be increased.

Please refer to FIG. 2 again. If the determination in the step S1 indicates that the working mode of the first energy conversion device 2 is the operating mode and determination in the sub-step S2A indicates that the energy storage battery 20 in the first energy conversion device 2 needs to undergo the charging operation, a sub-step S3B of the step S3 is performed to determine whether the SOC of the energy storage battery 20 in the first energy conversion device 2 is too high. If the SOC of the energy storage battery 20 in the first energy conversion device 2 is greater than a first upper threshold, it is determined that the SOC of the energy storage battery 20 in the first energy conversion device 2 is too high.

The first lower threshold is less than the first upper threshold. In addition, the first lower threshold and the first upper threshold may be set according to the practical requirements.

Furthermore, the working mode of the first energy conversion device 2 may be switched according to the comparison result of the sub-step S3B. If the comparison result of the sub-step S3B indicates that the SOC of the energy storage battery 20 in the first energy conversion device 2 is less than the first upper threshold, the working mode of the first energy conversion device 2 is maintained in the operating mode. Whereas, if the comparison result of the sub-step S3B indicates that the SOC of the energy storage battery 20 in the first energy conversion device 2 is greater than the first upper threshold, a sub-step S3C of the step S3 is performed to determine the working mode of the first energy conversion device 2 according to the number of energy conversion devices 2 currently in the operating mode. For example, if the number of energy conversion devices 2 currently in the operating mode is greater than or equal to two, the working mode of the first energy conversion device 2 is switched to the standby mode. Whereas, if the number of energy conversion devices 2 currently in the operating mode is equal to one, the working mode of the first energy conversion device 2 is maintained in the operating mode. Since only one energy conversion device 2 (i.e., the first energy conversion device 2) is in the operating mode, the first energy conversion device 2 further adjusts the frequency of the output voltage. That is, the frequency of the output voltage that is outputted from the first energy conversion device 2 to the common terminal COM is increased, and the inverter 3 correspondingly reduces the output power.

The relationship between the output power and the voltage frequency of the inverter 3 in the power supply system 1 may be seen in FIG. 4. If the frequency of the voltage at the common terminal COM is greater than fl, the output power of the inverter 3 gradually decreases from 100% to zero as the frequency increases. In this situation, only one energy conversion device 2 is in operating mode, but the other energy conversion devices 2 are in standby mode. This situation can be regarded as a special operating mode, also referred as a stand-alone operating mode.

Please refer to FIG. 2 again. If the determination in the step S1 indicates that the working mode of the first energy conversion device 2 is the standby mode, a sub-step S2B of the step S2 is performed to determine whether the first energy conversion device 2 needs to undergo the charging operation or the discharging operation according to the power reference command. That is, the sub-step S2B is performed to determine whether the energy storage battery 20 in the first energy conversion device 2 needs to undergo the charging operation or the discharging operation.

If the determination in the sub-step S2B indicates that the energy storage battery 20 in the first energy conversion device 2 needs to undergo the discharging operation, a sub-step S3D of the step S3 is performed to determine whether the SOC of the energy storage battery 20 in the first energy conversion device 2 is too low. If the SOC of the energy storage battery 20 in the first energy conversion device 2 is less than a second lower threshold, it is determined that the SOC of the energy storage battery 20 in the first energy conversion device 2 is too low. The second lower threshold is greater than the first lower threshold. In this way, the whole power supply system 1 may be operated normally. Furthermore, the working mode of the first energy conversion device 2 can be switched according to the comparison result of the sub-step S3D. If the comparison result of the sub-step S3D indicates that the SOC of the energy storage battery 20 in the first energy conversion device 2 is less than the second lower threshold, the working mode of the first energy conversion device 2 is maintained in the standby mode. Whereas, if the comparison result of the sub-step S3D indicates that the SOC of the energy storage battery 20 in the first energy conversion device 2 is greater than the second lower threshold, the working mode of the first energy conversion device 2 is switched to the operating mode.

Furthermore, if the comparison result of the sub-step S3D indicates that the SOC of the energy storage battery 20 in the first energy conversion device 2 is greater than the second lower threshold, a sub-step S3E of the step S3 is performed to determine the working mode of the first energy conversion device 2 according to the number of energy conversion devices 2 currently in the operating mode. For example, if the number of energy conversion devices 2 currently in the operating mode is greater than or equal to one, the working mode of the first energy conversion device 2 is switched directly to the operating mode. Whereas, if the number of energy conversion devices 2 currently in the operating mode is zero, a sub-step S3F of the step S3 is performed. That is, the first energy conversion device 2 is activated to form the local micro-grid. After the first energy conversion device 2 is activated to form the local micro-grid, the working mode of the first energy conversion device 2 is switched to the operating mode.

Please refer to FIG. 2 again. If the determination in the step S1 indicates that the working mode of the first energy conversion device 2 is the standby mode and the determination in the sub-step S2B indicates that the energy storage battery 20 in the first energy conversion device 2 needs to undergo the charging operation, a sub-step S3G of the step S3 is performed to determine whether the SOC of the energy storage battery 20 in the first energy conversion device 2 is too high. If the SOC of the energy storage battery 20 in the first energy conversion device 2 is greater than a second upper threshold, it is determined that the SOC of the energy storage battery 20 in the first energy conversion device 2 is too high. The second upper threshold is less than the first upper threshold, and the second lower threshold is less than the second upper threshold. Consequently, the normal operations of the power supply system 1 is achieved.

Furthermore, the working mode of the first energy conversion device 2 can be switched according to the comparison result of the sub-step S3G. If the comparison result of the sub-step S3G indicates that the SOC of the energy storage battery 20 in the first energy conversion device 2 is greater than the second upper threshold, the working mode of the first energy conversion device 2 is maintained in the standby mode. Whereas, if the comparison result of the sub-step S3G indicates that the SOC of the energy storage battery 20 in the first energy conversion device 2 is less than the second upper threshold, the working mode of the first energy conversion device 2 is switched to the operating mode.

In an embodiment, if the comparison result of the sub-step S3G indicates that the SOC of the energy storage battery 20 in the first energy conversion device 2 is less than the second upper threshold, the sub-step S3E of the step S3 is performed to determine the working mode of the first energy conversion device 2 according to the number of energy conversion devices 2 currently in the operating mode. For example, if the number of energy conversion devices 2 currently in the operating mode is greater than or equal to one, the working mode of the first energy conversion device 2 is switched directly to the operating mode. Whereas, if the number of energy conversion devices 2 currently in the operating mode is zero, a sub-step S3F of the step S3 is performed. That is, the first energy conversion device 2 is activated to form the local micro-grid. After the first energy conversion device 2 is activated to form the local micro-grid, the working mode of the first energy conversion device 2 is switched to the operating mode.

In accordance with the power supply system and the control method of the present disclosure, the SOC of the energy storage battery in each energy conversion device may be stabilized within the reasonable threshold range. That is, it is not necessary to maintain the energy storage batteries of different energy conversion devices at the similar SOC levels. Consequently, the safety and reliability of the power supply system can be effectively improved. Furthermore, since the control strategy of the power supply system is simplified, the cost of the power supply system can be effectively reduced.

From the above descriptions, the present disclosure provides a power supply system and a control method for the power supply system. Each energy conversion device executes the same control method.

Furthermore, the working mode of each energy conversion device can be flexibly switched between the operating mode and the standby mode according to the SOC of its own energy storage battery and the power reference command. In most cases, all energy conversion devices have no master-slave distinction, but adopt the decentralized control configuration. Consequently, the power supply system does not need to obtain detailed information of all power conversion systems in the microgrid to make the control strategy, making the control strategy of the power supply system relatively simple. Furthermore, since the control strategy only affects the behavior of each energy conversion device itself, the degree of coupling between various energy conversion devices is low. Consequently, the stability and the reliability of the power supply system can be effectively enhanced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for a power supply system, the power supply system comprising an inverter and a plurality of energy conversion devices, the plurality of energy conversion devices being electrically connected to each other, an output terminal of each of the plurality of energy conversion devices being electrically connected to the inverter via a common terminal, each of the plurality of energy conversion devices comprising an energy storage battery, a power supply sub-device and a power conversion system, the control method comprising:
(S1) determining a working mode of a first energy conversion device of the plurality of energy conversion devices, wherein the working mode comprises an operating mode and a standby mode;
(S2) determining whether the first energy conversion device requires charging or discharging according to a power reference command; and
(S3) determining whether to switch the working mode of the first energy conversion device based on a state of charge of the energy storage battery in the first energy conversion device.

2. The control method according to claim 1, wherein when a determination in the step (S1) indicates that the working mode of the first energy conversion device is the operating mode and a determination in the step (S2) indicates that the energy storage battery in the first energy conversion device requires discharging, the step (S3) further comprises:
determining whether to switch the working mode of the first energy conversion device based on a comparison result of the state of charge of the energy storage battery in the first energy conversion device with a first lower threshold, wherein:
if the state of charge of the energy storage battery in the first energy conversion device is less than the first lower threshold, the working mode of the first energy conversion device is switched to the standby mode;
if the state of charge of the energy storage battery in the first energy conversion device is greater than the first lower threshold, the working mode of the first energy conversion device is maintained in the operating mode.

3. The control method according to claim 2, wherein if the state of charge of the energy storage battery in the first energy conversion device is less than the first lower threshold, switching the working mode of the first energy conversion device to the standby mode further comprises:
controlling the power supply sub-device in the first energy conversion device to charge the energy storage battery in the first energy conversion device via the corresponding power conversion system.

4. The control method according to claim 1, wherein when a determination in the step (S1) indicates that the working mode of the first energy conversion device is the operating mode and a determination in the step (S2) indicates that the energy storage battery in the first energy conversion device requires charging, the step (S3) further comprises:
determining whether to switch the working mode of the first energy conversion device based on a comparison result of the state of charge of the energy storage battery in the first energy conversion device with a first upper threshold, wherein:
if the state of charge of the energy storage battery in the first energy conversion device is less than the first upper threshold, the working mode of the first energy conversion device is maintained in the operating mode;
if the state of charge of the energy storage battery in the first energy conversion device is greater than the first upper threshold, whether to switch the working mode of the first energy conversion device to the standby mode or maintain the working mode of the first energy conversion device in the operating mode is determined based on a number of energy conversion devices currently in the operating mode.

5. The control method according to claim 4, wherein:
if the number of energy conversion devices currently in the operating mode is greater than or equal to two, the working mode of the first energy conversion device is switched to the standby mode;
if the number of energy conversion devices currently in the operating mode is equal to one, the working mode of the first energy conversion device is maintained in the operating mode, and a frequency of an output voltage of the first energy conversion device is increased.

6. The control method according to claim 1, wherein when a determination in the step (S1) indicates that the working mode of the first energy conversion device is the standby mode and a determination in the step (S2) indicates that the energy storage battery in the first energy conversion device requires discharging, the step (S3) further comprises a step of:
determining whether to switch the working mode of the first energy conversion device based on a comparison result of the state of charge of the energy storage battery in the first energy conversion device with a second lower threshold, wherein:
if the state of charge of the energy storage battery in the first energy conversion device is less than the second lower threshold, the working mode of the first energy conversion device is maintained in the standby mode;
if the state of charge of the energy storage battery in the first energy conversion device is greater than the second lower threshold, the working mode of the first energy conversion device is switched to the operating mode.

7. The control method according to claim 6, wherein if the state of charge of the energy storage battery in the first energy conversion device is greater than the second lower threshold, switching the working mode of the first energy conversion device to the operating mode further comprises:
determining a manner of switching the working mode of the first energy conversion device to the operating mode based on a number of energy conversion devices currently in the operating mode, wherein:
if the number of energy conversion devices currently in the operating mode is greater than or equal to one, the working mode of the first energy conversion device is switched directly to the operating mode;
if the number of energy conversion devices currently in the operating mode is equal to zero, the working mode of the first energy conversion device is switched to the operating mode after the first energy conversion device is activated to form a local micro-grid.

8. The control method according to claim 1, wherein if a determination in the step (S1) indicates that the working mode of the first energy conversion device is the standby mode and a determination in the step (S2) indicates that the energy storage battery in the first energy conversion device requires charging, the step (S3) further comprises:
determining whether to switch the working mode of the first energy conversion device based on a comparison result of the state of charge of the energy storage battery in the first energy conversion device with a second upper threshold, wherein:
if the state of charge of the energy storage battery in the first energy conversion device is greater than the second upper threshold, the working mode of the first energy conversion device is maintained in the standby mode;
if the state of charge of the energy storage battery in the first energy conversion device is less than the second upper threshold, the working mode of the first energy conversion device is switched to the operating mode.

9. The control method according to claim 8, wherein, if the state of charge of the energy storage battery in the first energy conversion device is less than the second upper threshold, switching the working mode of the first energy conversion device to the operating mode further comprises:
determining a manner of switching the working mode of the first energy conversion device to the operating mode based on a number of energy conversion devices currently in the operating mode, wherein:
if the number of energy conversion devices currently in the operating mode is greater than or equal to one, the working mode of the first energy conversion device is switched directly to the operating mode;
if the number of energy conversion devices currently in the operating mode is equal to zero, the working mode of the first energy conversion device is switched to the operating mode after the first energy conversion device is activated to form a local micro-grid.

10. The control method according to claim 1, wherein when a determination in the step (S1) indicates that the working mode of the first energy conversion device is the operating mode, the step (S2) further comprises:
determining the power reference command based on an average power of all energy conversion devices currently in the operating mode and an output power of the power supply sub-device in the first energy conversion device.

11. The control method according to claim 1, wherein when a determination in the step (S1) indicates that the working mode of the first energy conversion device is the standby mode, the step (S2) further comprises:
determining the power reference command based on an average power of all energy conversion devices currently in the operating mode.

12. A power supply system, comprising:
an inverter; and
a plurality of energy conversion devices, wherein the plurality of energy conversion devices are electrically connected to each other, an output terminal of each of the plurality of energy conversion devices is electrically connected to the inverter via a common terminal, each of the plurality of energy conversion devices comprises an energy storage battery, a power supply sub-device and a power conversion system, wherein the plurality of energy conversion devices comprises a first energy conversion device, and the first energy conversion device is configured to perform a control method, wherein the control method comprises:
(S1) determining a working mode of the first energy conversion device, wherein the working mode comprises an operating mode and a standby mode;
(S2) determining whether the first energy conversion device requires charging or discharging according to a power reference command; and
(S3) determining whether to switch the working mode of the first energy conversion device based on a state of charge of the energy storage battery in the first energy conversion device.

13. The power supply system according to claim 12, wherein when a determination in the step (S1) indicates that the working mode of the first energy conversion device is the operating mode and a determination in the step (S2) indicates that the energy storage battery in the first energy conversion device requires discharging, the step (S3) further comprises:
determining whether to switch the working mode of the first energy conversion device based on a comparison result of the state of charge of the energy storage battery in the first energy conversion device with a first lower threshold, wherein:
if the state of charge of the energy storage battery in the first energy conversion device is less than the first lower threshold, the working mode of the first energy conversion device is switched to the standby mode;
if the state of charge of the energy storage battery in the first energy conversion device is greater than the first lower threshold, the working mode of the first energy conversion device is maintained in the operating mode.

14. The power supply system according to claim 13, wherein if the state of charge of the energy storage battery in the first energy conversion device is less than the first lower threshold, switching the working mode of the first energy conversion device to the standby mode further comprises:
controlling the power supply sub-device in the first energy conversion device to charge the energy storage battery in the first energy conversion device via the corresponding power conversion system.

15. The power supply system according to claim 12, wherein when a determination in the step (S1) indicates that the working mode of the first energy conversion device is the operating mode and a determination in the step (S2) indicates that the energy storage battery in the first energy conversion device requires charging, the step (S3) further comprises:
determining whether to switch the working mode of the first energy conversion device based on a comparison result of the state of charge of the energy storage battery in the first energy conversion device with a first upper threshold, wherein:
if the state of charge of the energy storage battery in the first energy conversion device is less than the first upper threshold, the working mode of the first energy conversion device is maintained in the operating mode;
if the state of charge of the energy storage battery in the first energy conversion device is greater than the first upper threshold, whether to switch the working mode of the first energy conversion device to the standby mode or maintain the working mode of the first energy conversion device in the operating mode is determined based on a number of energy conversion devices currently in the operating mode.

16. The power supply system according to claim 15, wherein:
if the number of energy conversion devices currently in the operating mode is greater than or equal to two, the working mode of the first energy conversion device is switched to the standby mode;
if the number of energy conversion devices currently in the operating mode is equal to one, the working mode of the first energy conversion device is maintained in the operating mode, and a frequency of an output voltage of the first energy conversion device is increased.

17. The power supply system according to claim 12, wherein when a determination in the step (S1) indicates that the working mode of the first energy conversion device is the standby mode and a determination in the step (S2) indicates that the energy storage battery in the first energy conversion device requires discharging, the step (S3) further comprises:
determining whether to switch the working mode of the first energy conversion device based on a comparison result of the state of charge of the energy storage battery in the first energy conversion device with a second lower threshold, wherein:
if the state of charge of the energy storage battery in the first energy conversion device is less than the second lower threshold, the working mode of the first energy conversion device is maintained in the standby mode;
if the state of charge of the energy storage battery in the first energy conversion device is greater than the second lower threshold, the working mode of the first energy conversion device is switched to the operating mode.

18. The power supply system according to claim 17, wherein if the state of charge of the energy storage battery in the first energy conversion device is greater than the second lower threshold, switching the working mode of the first energy conversion device to the operating mode further comprises:
determining a manner of switching the working mode of the first energy conversion device to the operating mode based on a number of energy conversion devices currently in the operating mode, wherein:
if the number of energy conversion devices currently in the operating mode is greater than or equal to one, the working mode of the first energy conversion device is switched directly to the operating mode;
if the number of energy conversion devices currently in the operating mode is equal to zero, the working mode of the first energy conversion device is switched to the operating mode after the first energy conversion device is activated to form a local micro-grid.

19. The power supply system according to claim 12, wherein if a determination in the step (S1) indicates that the working mode of the first energy conversion device is the standby mode and a determination in the step (S2) indicates that the energy storage battery in the first energy conversion device requires charging, the step (S3) further comprises:
determining whether to switch the working mode of the first energy conversion device based on a comparison result of the state of charge of the energy storage battery in the first energy conversion device with a second upper threshold, wherein:
if the state of charge of the energy storage battery in the first energy conversion device is greater than the second upper threshold, the working mode of the first energy conversion device is maintained in the standby mode;
if the state of charge of the energy storage battery in the first energy conversion device is less than the second upper threshold, the working mode of the first energy conversion device is switched to the operating mode.

20. The power supply system according to claim 19, wherein if the state of charge of the energy storage battery in the first energy conversion device is less than the second upper threshold, switching the working mode of the first energy conversion device to the operating mode further comprises:
determining a manner of switching the working mode of the first energy conversion device to the operating mode based on a number of energy conversion devices currently in the operating mode, wherein:
if the number of energy conversion devices currently in the operating mode is greater than or equal to one, the working mode of the first energy conversion device is switched directly to the operating mode;
if the number of energy conversion devices currently in the operating mode is equal to zero, the working mode of the first energy conversion device is switched to the operating mode after the first energy conversion device is activated to form a local micro-grid.

21. The power supply system according to claim 12, wherein when a determination in the step (S1) indicates that the working mode of the first energy conversion device is the operating mode, the step (S2) further comprises:
determining the power reference command based on an average power of all energy conversion devices currently in the operating mode and an output power of the power supply sub-device in the first energy conversion device.

22. The power supply system according to claim 12, wherein when a determination in the step (S1) indicates that the working mode of the first energy conversion device is the standby mode, the step (S2) further comprises:
determining the power reference command based on an average power of all energy conversion devices currently in the operating mode.
